(19) United States
(12) Patent Application Publication
(10) Pub. No.: US 2015/0007438 A1
(43) Pub. Date: Jan. 8, 2015

(54) LEVEL

(71) Applicant: Mikio Kajiki, Tokyo (JP)

(72) Inventor: Mikio Kajiki, Tokyo (JP)

(21) Appl. No.: 14/497,197

(22) Filed: Sep. 25, 2014

Related U.S. Application Data
(63) Continuation of application No. PCT/JP2013/054667, filed on Feb. 25, 2013.

(30) Foreign Application Priority Data
Mar. 27, 2012 (JP) 2012-070523
Jun. 19, 2012 (JP) 2012-137615

(51) Int. Cl. G01C 9/26; G01C 9/34

(52) U.S. Cl. CPC G01C 9/26; G01C 9/34
USPC 33/389

(57) ABSTRACT

A level can include a measurement base portion having a reference surface arranged thereon to abut on a measurement surface and a bubble tube having a liquid and a bubble enclosed therein, the bubble tube arranged to be inclined at a certain angle in such a fashion that the bubble tube is away from or near to the reference surface in a direction from a peripheral portion of the reference surface toward a central portion of the reference surface.

### CROSS REFERENCE TO RELATED APPLICATIONS

This is a continuation application of International Patent Application No. PCT/JP2013/054667 filed on Feb. 25, 2013 claiming priority upon Japanese Patent Application Nos. 2012-070523 and 2012-137615 filed on Mar. 27, 2012 and Jun. 19, 2012, respectively, the full contents of which are incorporated herein by reference.

### BACKGROUND

1. Technical Field

The present disclosure relates to a level.

2. Description of the Related Art

Conventionally, a scale has been disposed on the surface of a level with a single bubble tube such that an amount of displacement of the bubble is read out from the scale in accordance with an inclination of the measurement surface, thereby measuring an amount of the inclination. The scale has been disposed by an amount of inclination per scale=0.02 mm/m as a sensitivity, for instance, and an inclination amount has been measured from an amount of displacement of the bubble with respect to the scale.

Upon change in size of the bubble due to the influence of temperature under measurement environment, however, such a change has resulted in measurement errors. In other words, in order to measure an inclination amount precisely, a size of the bubble at a measurement time should have been a predetermined value. Thus, in order to carry out a precise measurement, it is explicitly described in JIS B7510 to adjust a bubble size in advance as a preparation for measurement work such that the bubble is identical in size to a predetermined measurement scale. For such a purpose, an authenticated level has been provided with a bubble chamber for adjusting the size of a bubble (see e.g. Japanese unexamined patent application publication No. 2004-163381).

The above-described conventional level has required adjustment and confirmation work of the bubble size at each measurement, so that the bubble chamber has been a factor in the increase in production cost.

### BRIEF SUMMARY

The present disclosure is made in view of the above-mentioned circumstance, and it is an object to provide a level that can measure an inclination state without the influence of a change in the bubble size to facilitate the measurement work as well as to enable the suppression of production cost.

A level according to one or more embodiments includes: a measurement base portion having a reference surface arranged thereon to abut on a measurement surface; and a bubble tube having a liquid and a bubble enclosed therein, the bubble tube arranged to be inclined at a certain angle in such a fashion that the bubble tube is away from or near to the reference surface in a direction from a peripheral portion of the reference surface toward a central portion of the reference surface.

According to one or more embodiments, a displacement sensitivity of the bubble in the bubble tube can be set to a predetermined value, and a change in a bubble position can be kept at constant.

Further, in the level according to one or more embodiments, the bubble tube is formed as a pair of bubble tubes mounted on the measurement base portion, the pair of bubble tubes including a first bubble tube and a second bubble tube having a liquid and a first bubble enclosed therein, and having base-end sides thereof connected in communication with each other such that the first bubble is movable therethrough, the first bubble tube and the second bubble tube arranged to be inclined with respect to the reference surface in such a fashion that the base-end sides thereof are greater in distance from the reference surface than distal-end sides thereof while the first bubble formed in a size to extend from the first bubble tube to the second bubble tube.

According to one or more embodiments, in the case that the measurement surface is inclined with respect to a horizontal plane, when the reference surface abuts on the measurement surface, the first bubble moves through the inside of the first and second bubble tubes on the base-end sides thereof, and a relative position between a bubble end on the side of the first bubble tube and a bubble end on the side of the second bubble tube changes. At this time, by measuring such changes in a distance between the ends of the bubbles, an inclination degree of the measurement surface can be measured. Further, since the first bubble is always placed on the base-end side of the first and second bubble tubes due to their inclined position, the first bubble can move smoothly in an integrated manner and a difference amount at the bubble end can be suitably measured.

Still further, the level according to one or more embodiments further includes a sensitivity-adjustment unit for changing an inclination angle of the bubble tubes with respect to the reference surface.

According to one or more embodiments, since a mobility of the bubble changes when an inclination angle of the bubble tubes changes with respect to the reference surface, adjustment to a desired measurement sensitivity is possible in accordance with the setting of a desired inclination angle of the bubble tubes by the sensitivity-adjustment unit.

Still further, in the level according to one or more embodiments, the first bubble tube and the second bubble tube are formed in a bilaterally symmetrical fashion with respect to a first central axis line.

According to one or more embodiments, a production cost can be suppressed and the positioning of the first bubble and the reading-out of a difference amount at the bubble ends can be carried out more easily.

Still further, the level according to one or more embodiments further includes a scale unit having a plurality of ticks provided at regular intervals on a moving region of a bubble end of the first bubble in the first bubble tube and the second bubble tube.

According to one or more embodiments, a distance between the bubble end on the first bubble tube side and the bubble end on the second bubble tube side can be measured more easily and precisely.

Still further, in the level according to one or more embodiments, the scale unit is movably arranged with respect to the first bubble tube and the second bubble tube.

According to one or more embodiments, each of the bubble ends of the first bubble can be always on the ticks by moving the scale unit so that a distance between the bubble ends can be measured more suitably.

Still further, the level according to one or more embodiments further includes a third bubble tube and a fourth bubble tube formed as a pair having a liquid and a second bubble enclosed therein, the third bubble tube and the fourth bubble tube being arranged on the measurement base portion and having the base-end sides thereof connected in communication with each other in such a fashion that the second bubble is movable between the third bubble tube and the fourth bubble tube, the base-end sides of the first bubble tube and the second bubble and the base-end sides of the third bubble tube and the fourth bubble tube being arranged to be opposite to each other.

According to one or more embodiments, an absolute value of an inclination angle of a measurement surface can be measured by measuring the measurement surface at a position where a distance between the bubble ends of the first and second bubble tubes is identical to a distance between the bubble ends of the third and fourth bubble tubes.

Still further, in the level according to one or more embodiments, the base-end sides of the third bubble tube and the fourth bubble tube are connected in communication with the base-end sides of the first bubble tube and the second bubble tube, and the first bubble and the second bubble are merged into a single bubble.

According to one or more embodiments, since no adjustment is required to make the first and second bubble tubes and the third and fourth bubble tubes identical at the production, the production cost can be suppressed more significantly.

Still further, in the level according to one or more embodiments, the third bubble tube and the fourth bubble tube are formed in a bilaterally symmetrical fashion with respect to a second central axis line.

According to one or more embodiments, a production cost can be more suppressed and the position adjustment of the bubbles in the third and fourth bubble tubes and the reading-out of a difference amount at the bubble end can be carried out more easily.

Still further, the level according to one or more embodiments further includes a fifth bubble tube and a sixth bubble tube formed as a pair having the base-end sides thereof connected in communication with each other as well as connected in communication with base-end sides of the first bubble tube and the second bubble tube so that the fifth bubble tube and the sixth bubble tube have the liquid and the first bubble enclosed therein, the fifth bubble tube and the sixth bubble tube being arranged in a bilaterally symmetrical fashion in an inside between the first bubble tube and the second bubble tube, or in an outside of the first bubble tube and the second bubble tube.

According to one or more embodiments, a bubble is more sensitively movable with the increase in a distance between the bubble tubes. As a result, since a distance between the first and second bubble tubes is different from a distance between the fifth and sixth bubble tubes, an inclination state can be measured with a different sensitivity in the level.

Still further, the level according to one or more embodiments further includes a body base portion mounted on the measurement base portion arranged with the first bubble tube and the second bubble tube, and a measurement-angle correction unit for adjusting an inclination angle of the body base portion with respect to the reference surface.

According to one or more embodiments, a horizontal degree of the body base portion with respect to the reference surface can be adjusted, and the measurement can be carried out with higher accuracy.

Still further, in the level according to one or more embodiments, when the bubble tube is viewed from a front with respect to the reference surface, a pair of reading-out positions for bubble ends of the bubble are set across a central axis line of the bubble tube.

According to one or more embodiments, an inclination amount can be measured with respect to the horizontal plane of the measurement surface in a direction perpendicular to the central axis line of the bubble tube by measuring a difference from a bubble end position at each reading-out position when in a horizontal state.

Still further, in the level according to one or more embodiments, each of the bubble tubes is arranged in a bent or curved shape at the central portion or in the vicinity of the central portion, of the reference surface.

According to one or more embodiments, an inclination angle of the bubble tube with respect to the reference surface can be easily changed by rotating the bubble tube itself about the central axis line.

Still further, in the level according to one or more embodiments, each of the bubble tubes has a region in the vicinity of the central axis line thereof is recessed more than a region away from the central axis line thereof.

Still further, in the level according to one or more embodiments, each of the bubble tubes has a protrusion formed in a region away from the central axis line thereof in an inside thereof.

According to one or more embodiments, since a region occupied by the bubble in the bubble tube is larger as the outside is further away from the central axis line, the influence of a distortion on a bubble reading-out surface over the bubble end position is suppressed, so that a change amount of the bubble end can be measured more precisely.

According to the present disclosure, an inclination state can be measured without the influence of changes in a bubble size, the measurement work can be facilitated and production cost can be suppressed.

### BRIEF DESCRIPTION OF THE DRAWINGS

For more thorough understanding of the present disclosure and advantages thereof, the following descriptions should be read in conjunction with the accompanying drawings, in which:

FIG. 1 depicts a perspective view of a level according to a first embodiment.

FIG. 2 depicts a diagram for explaining an operation of the level according to the first embodiment.

FIG. 3 depicts a diagram for explaining a measurement method by the level according to the first embodiment.

FIG. 4 depicts a perspective view of a level according to a second embodiment.

FIG. 5 depicts a schematic diagram of a relevant part of a level according to a third embodiment.

FIG. 6 depicts an overall schematic diagram of a level according to a fourth embodiment.

FIG. 7 depicts a diagram for explaining a measurement method by the level according to the fourth embodiment.

FIG. 8 depicts a schematic diagram of a relevant part of a modified example of the level according to the fourth embodiment.

FIG. 9 depicts a schematic diagram of a relevant part of a level according to a fifth embodiment.

FIG. 10 depicts a schematic diagram of a relevant part of a level according to a sixth embodiment.

FIG. 11 depicts a schematic diagram of a relevant part of a level according to a seventh embodiment.

FIG. 12 depicts a diagram for explaining a measurement method by the level according to the seventh embodiment.

FIG. 13 depicts a schematic diagram of a relevant part of a level according to an eighth embodiment.

FIG. 14 depicts a schematic diagram of a relevant part of a level according to another embodiment.

FIG. 15 depicts a schematic diagram of a relevant part of a level according to still another embodiment.

### DETAILED DESCRIPTION

### First Embodiment

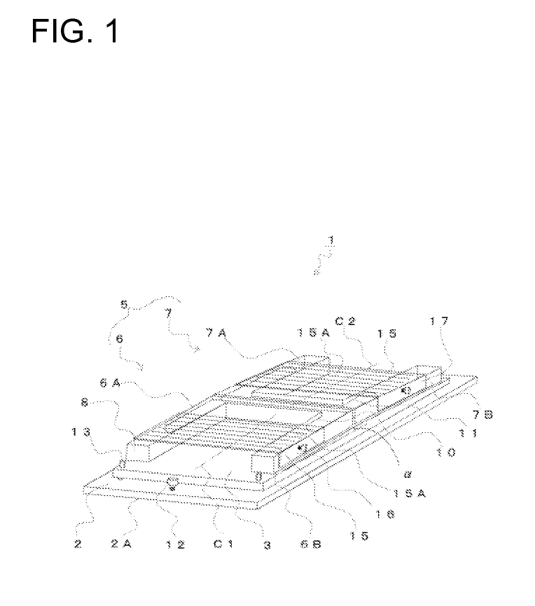

The first embodiment will be described with reference to FIGS. 1 through 3.

As illustrated in FIG. 1, a level 1 according to the first embodiment includes a measurement base portion 2 provided with a reference surface 2A to abut on a measurement surface (not illustrated), a body base portion 3 movably mounted on the measurement base portion 2, and a bubble tube body 5 mounted on the body base portion 3.

The bubble tube body 5 is provided with a first bubble tube body 6 having a first bubble tube 6A and a second bubble tube 6B, and a second bubble tube body 7 having a third bubble tube 7A and a fourth bubble tube 7B such that the first bubble tube body 7 has the same shape as the first bubble tube body 6.

The first bubble tube 6A and the second bubble tube 6B are formed as a pair of bubble tubes in which a liquid 8 and a first bubble 10 are enclosed, the base-end sides of the bubble tubes are connected in communication with each other such that the first bubble 10 is movable, and the bubble tubes are formed in bilateral symmetry with respect to a first central axis line C1 and are mounted on the body base portion 3. The distal-end sides of the first bubble tube 6A and the second bubble tube 6B extend substantially in parallel with the first central axis line C1.

The third bubble tube 7A and the fourth bubble tube 7B are formed as a pair of bubble tubes in which the liquid 8 and a second single bubble 11 that is substantially the same in size as the first bubble 10 are enclosed. The base-end sides of the bubble tubes are connected in communication with each other such that the second bubble 11 is movable, and the bubble tubes are formed in bilateral symmetry with respect to a second central axis line C2 and are mounted on the body base portion 3. The distal-end sides of the third bubble tube 7A and the fourth bubble tube 7B extend substantially in parallel with the second central axis line C2.

In the first bubble tube body 6 and the second bubble tube body 7, the base-end sides of the first bubble tube 6A and the second bubble tube 6B and the base-end sides of the third bubble tube 7A and the fourth bubble tube 7B are mutually disposed opposite each other, and the first central axis line C1 and the second central axis line C2 are provided in a pair arrangement in a direction perpendicular to the reference surface 2A on the same virtual plane (not illustrated).

Here, the base-end sides of the first bubble tube 6A and the second bubble tube 6B and the base-end sides of the third bubble tube 7A and the fourth bubble tube 7B each are more inclined than each distal-end side at a sensitivity-setting angle α in a direction away from the reference surface 2A.

The measurement base portion 2 is provided with a sensitivity-setting zero-angle adjustment unit (sensitivity-adjustment unit) 12 for changing a sensitivity-setting angle that becomes an inclination angle defined between the first central axis line C1 and the second central axis line C2 with respect to the reference surface 2A. The body base portion 3 is also provided with a measurement zero-angle correction unit (measurement-angle correction unit) 13 for adjusting an inclination angle of the body base portion 3 with respect to the reference surface 2A.

On a moving region of a bubble end of the first bubble 10 in the first bubble tube body 6, a first scale unit (scale unit) 16 with a reference tick (tick) 15 and a plurality of measurement ticks 15A disposed at regular intervals with respect to the reference tick 15 is disposed movably with respect to the first bubble tube 6A and the second bubble tube 6B. Also, on a moving region of a bubble end of the second bubble 11 in the second bubble tube body 7, similarly to the first scale unit 16, a second scale unit 17 with the reference tick (tick) 15 and a plurality of measurement ticks 15A disposed at regular intervals with respect to the reference tick 15 is disposed movably with respect to the third bubble tube 7A and the fourth bubble tube 7B.

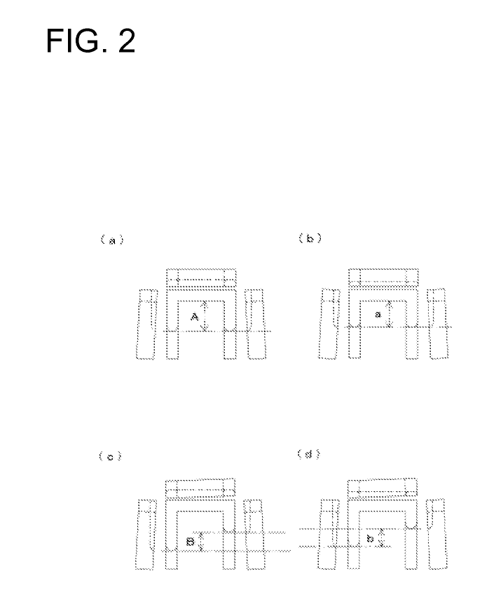

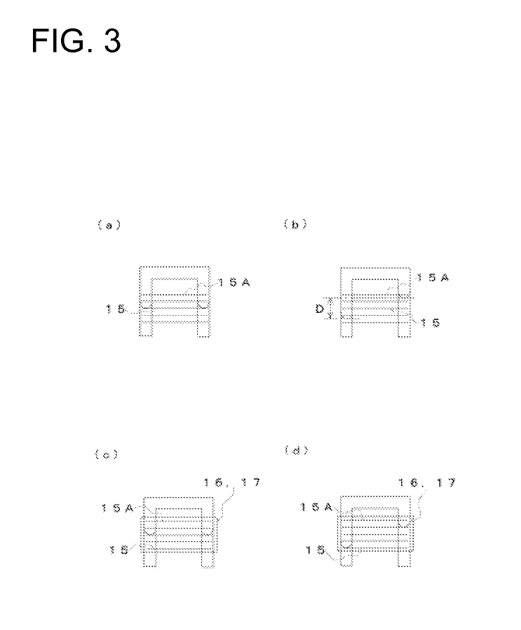

Next, operation of the level 1 of the embodiment will be explained with reference to FIGS. 2 and 3.

First, as a measurement preparation, the operation of the sensitivity-setting zero-angle adjustment unit 12 makes a difference amount between the bubble ends of the first bubble 10 with respect to the first bubble tube 6A and the second bubble tube 6B consistent with a difference amount between the bubble ends of the second bubble 11 with respect to the third bubble tube 7A and the fourth bubble tube 7B. With this, the sensitivity-setting angle α becomes an angle from the horizontal plane and a sensitivity-setting angle set for measurement.

Here, if the operation of the sensitivity-setting zero-angle adjustment unit 12 makes the difference amount between the bubble ends of the first bubble 10 in the first tube body 6 more different from the difference amount between the bubble ends of the second bubble 11 in the second bubble tube body 7, a direction of the measurement base portion 2 is changed by 180°. Again, in order to make the difference consistent with each other, the sensitivity-setting zero-angle adjustment unit 12 is operated.

Next, even if a direction of the body base portion 3 with respect to the measurement base unit 2 is changed by 180°, the measurement zero-angle correction unit 13 is operated to make the difference between the bubble ends of the first bubble 10 in the first tube body 6 identical to the difference between the bubble ends of the second bubble 11 in the second bubble tube body 7. With this, an angle with respect to the measured angle of the body base portion 3 itself is corrected to 0.

Here, since the enclosed bubble and liquid also move in the bubble tubes, even if the bubble becomes smaller in size in accordance with temperature changes, positions of the bubble ends in both bubble tubes only move in parallel in an upper direction of the drawings as illustrated in (a), (b) of FIG. 2 (i.e., A>a in the drawings) when in a horizontal state, so that the difference of the bubble ends remains unchanged.

On the other hand, at the time of inclination measurement, a displacement amount of the bubble is proportional to an inclination degree and an absolute value of its displacement amount is determined only by a sensitivity-setting angle. That is, as illustrated in FIGS. 2(c) and 2(d), the bubble as a whole moves in the upper direction but the difference of the bubble ends also remains unchanged (i.e., B=b in the drawings). Thus, precise inclination measurement can be facilitated without the influence of bubble size changes due to temperature.

At the time of measurement, when a difference amount is read out from the first scale unit 16 and the second scale unit 17, in the case where both the bubble ends are positioned at the reference tick 15 when in a horizontal state as illustrated in (a) of FIG. 3, a difference D between the bubble ends is caused at the time of inclination measurement as illustrated in (b) of FIG. 3. The difference at this time turns out to be three tick intervals. On the other hand, even when both the bubble ends are not positioned at the reference tick 15 in the horizontal state as illustrated in (c) of FIG. 3, the first scale unit 16 or the second scale unit 17 is moved at the inclination measurement to make one of the bubble ends consistent with the reference tick 15 so that a difference amount with the other of the bubble ends can be read out as three tick intervals at the time of measuring inclination as illustrated in (d) of FIG. 3.

In this way, when the sensitivity-setting angle is one degree, for instance, an inclination amount of 20/1000 is set to one tick interval of a difference amount between bubble ends, so that an absolute inclination amount can be measured from an inclination sensitivity per one tick and a difference amount between positions of the bubble ends.

According to the level 1, in the case where a measurement surface (not illustrated) is inclined with respect to the horizontal plane (not illustrated), when the reference surface 2A abuts on a measurement surface, the first bubble 10 moves in the base-end side of the first bubble tube 6A and the second bubble tube 6B, and the bubble end on the side of the first bubble tube 6A changes in relative position from the bubble end on the side of the second bubble tube 6B. In this case, an inclination degree of the measurement surface with respect to the horizontal plane can be measured by measuring a distance between the bubble ends in accordance with the first scale unit 16 and the second scale unit 17.

Further, since not only the first bubble tube body 6 but also the second bubble tube body 7 is provided, the measurement is carried out at a position where a distance between bubble ends of each of the first bubble tube 6A and the second bubble tube 6B is identical to a distance between bubble ends of each of the third bubble tube 7A and the fourth bubble tube 7B, so that an absolute amount of an inclination angle of the measurement surface (not illustrated) can be measured.

In particular, the base-end sides of the first bubble tube 6A and the second bubble tube 6B and the base-end sides of the third bubble tube 7A and the fourth bubble tube 7B are inclined at a sensitivity-setting angle in a direction further away from reference surface 2A than the distal-end sides, respectively. As a result, the first bubble 10 is always provided on the base-end sides of the first bubble tube 6A and the second bubble tube 6B and the second bubble 11 is always provided on the base-end sides of the third bubble tube 7A and the fourth bubble tube 7B. Hence, the first bubble 10 and the second bubble 11 can be moved smoothly in an integrated fashion.

In this case, since the sensitivity-setting zero-angle adjustment unit 12 is provided, by changing an inclination angle with respect to the reference surface 2A, it is possible to change a contact area of a bubble with an interior wall of the bubble tubes, so that a displacement sensitivity of the bubble can also be changed. For example, since the contact area of the bubble with the interior wall becomes smaller as an inclination angle with respect to the reference surface 2A is set to be larger, the displacement sensitivity of the bubble can be made dull.

Further, since the first scale unit 16 and the second scale unit 17 can be moved with respect to the first bubble tube body 6 and the second bubble tube body 7, respectively, the bubble ends can be always on the ticks by moving the first scale unit 16 and the second scale unit 17, so that the distance between the bubble ends can be measured more suitably.

Moreover, since the measurement zero-angle correction unit 13 is provided, the level degree of the body base portion 3 with respect to the reference surface 2A can be adjusted, so that a more precise measurement can be carried out.

### Second Embodiment

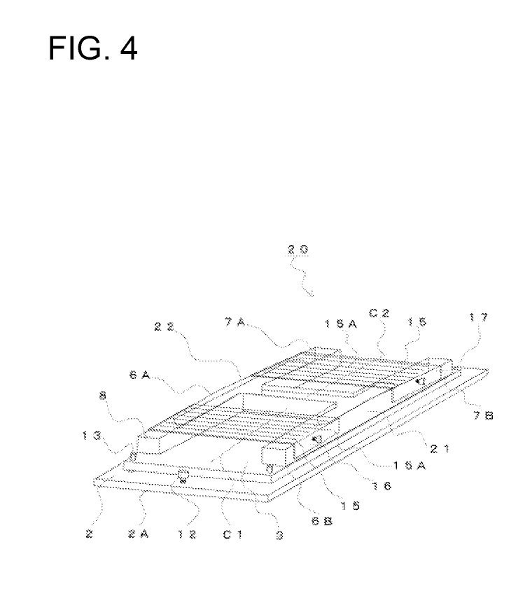

Next, the second embodiment will be explained with reference to FIG. 4.

Note that structural elements of this embodiment similar to those of the first embodiment described above represent the same reference numerals and descriptions thereof are omitted.

The second embodiment differs from the first embodiment in that a level 20 of the second embodiment is provided with a bubble tube body 21 into which the first bubble tube body 6 and the second bubble tube body 7 of the level 1 of the first embodiment are integrated.

That is, the base-end sides of the third bubble tube 7A and the fourth bubble tube 7B are connected in communication with the base-end sides of the first bubble tube 6A and the second bubble tube 6B in an integrated fashion, so that the first bubble 10 and the second bubble 11 are merged and provided as one single bubble 22.

Next, operation of the level 20 in relation to the present embodiment will be described.

The level 20 of the embodiment carries out measurement by operations similar to those of the level 1 in the first embodiment. First, as a preparation, the sensitivity-setting zero-angle adjustment unit 12 is operated to make a difference amount of the bubble end of the bubble 22 in the first bubble tube 6A and the second bubble tube 6B consistent with a difference amount of the bubble end of the bubble 22 in the third bubble tube 7A and the fourth bubble tube 7B. As a result, a sensitivity-setting angle α becomes an angle from the horizontal plane as well as a sensitivity-setting angle.

Here, if a correction operation by the sensitivity-setting zero-angle adjustment unit 12 makes a difference in a difference amount between the bubble ends of the bubble 22 larger, a direction of the measurement base portion 2 is changed by 180°. In order to make the difference amount consistent with each other, the sensitivity-setting zero-angle adjustment unit 12 is again operated.

Next, even if the direction of the body base portion 3 with respect to the measurement base unit 2 is changed by 180°, the measurement zero-angle correction unit 13 is operated to make the difference amount between the bubble ends of the single bubble 22 identical. With this, an angle with respect to the measurement angle of the body base portion 3 itself is adjusted. After this, measurement similar to that of the first embodiment is carried out to measure an absolute inclination amount.

According to the level 20, since the single bubble 22 is provided in the bubble tube 21 as a whole, it is not necessary to adjust the first bubble tube body 6 and the second bubble tube body 7 to merge into an identical bubble tube body at production, and production cost can be suppressed, accordingly.

### Third Embodiment

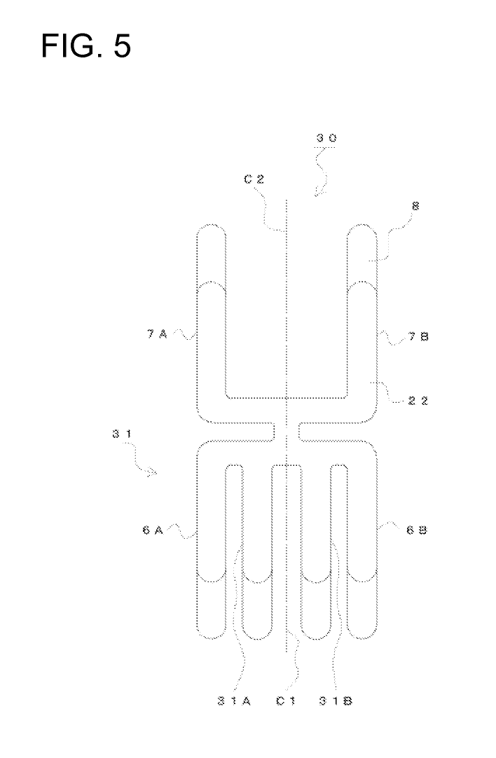

Next, the third embodiment will be explained with reference to FIG. 5.

Note that structural elements of this embodiment similar to those of the other embodiment described above represent the same reference numerals and their descriptions are omitted.

The third embodiment differs from the second embodiment in that a bubble tube body 31 in a level 30 of the present embodiment is provided with a fifth bubble tube 31A and a sixth bubble tube 31B.

The fifth bubble tube body 31A and the sixth bubble tube body 31B are formed in a pair of tubes, the base-end sides of which each are connected in communication with the base-end sides of the first bubble tube 6A and the second bubble tube 6B. The fifth bubble tube body 31A and the sixth bubble tube body 31B are provided in bilateral symmetry with respect to the first central axis line C1 on the inside of the first bubble tube 6A and the second bubble tube, and the liquid 8 and the single bubble 22 are enclosed therein. That is, in order to make the distance between the first bubble tube 6A and the second bubble tube 6B with respect to the first central axis line C1 different from the distance between the fifth bubble tube 31A and the sixth bubble tube 31B, the first bubble tube 6A and the second bubble tube 6B as well as the fifth bubble tube 31A and the sixth bubble tube 31B are provided in a comb-like shape.

Next, operation and effects of the level 30 in relation to the present embodiment will be described.

The level 30 of the embodiment also carries out the measurement by operations similar to those of the level 20 in the second embodiment. Here, the distance between the first bubble tube 6A and the second bubble tube 6B, the distance between the fifth bubble tube 31A and the sixth bubble tube 31B, the distance between the first bubble tube 6A and the fifth bubble tube 31A, and the distance between the second bubble tube 6B and the sixth bubble tube 31B are different from each other. In this case, since the bubble moves more sensitively as the distance between the bubble tubes is longer, the displacement sensitivity of the single bubble 22 is made to be set up separately among the distances of the bubble tubes. Hence, the single level 30 can measure inclination states of the measurement surface (not illustrated) with different sensitivities.

### Fourth Embodiment

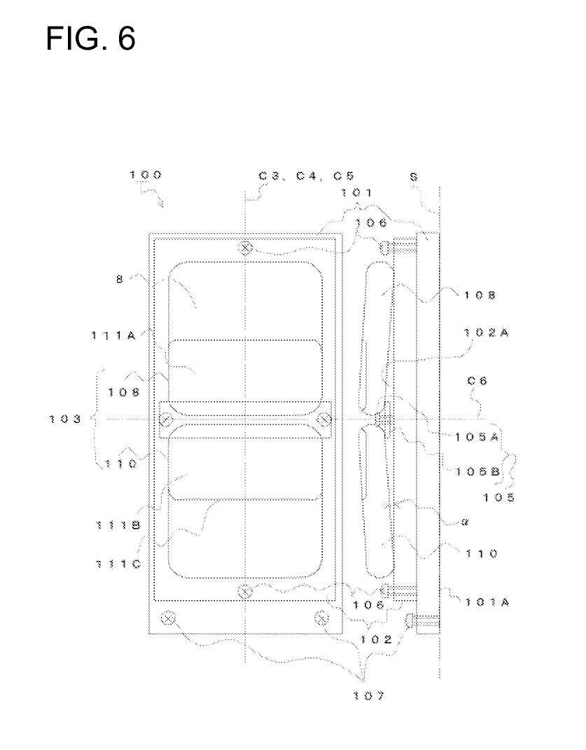

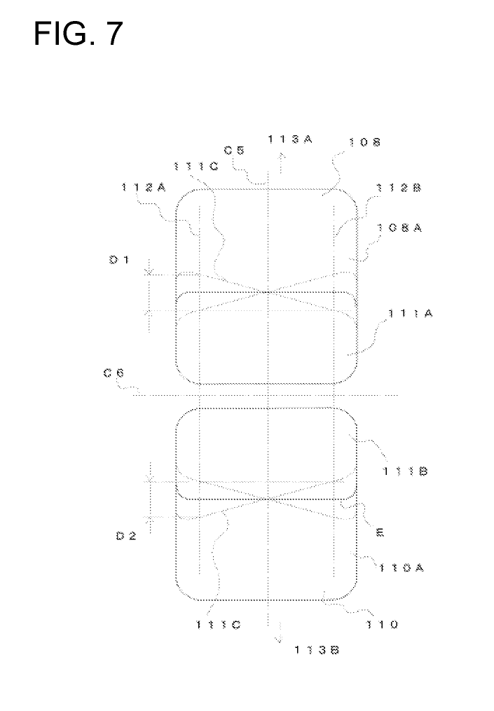

Next, the fourth embodiment will be explained with reference to FIGS. 6 and 7.

A level 100 of the present embodiment is provided with a measurement base portion 101 in which a reference surface 101A has a longitudinal direction and abuts on a measurement surface S, a body base portion 102 movably mounted on the measurement base portion 101, a bubble tube 103 movably mounted on the body base portion 102, a sensitivity-adjustment unit 105 that causes an inclination angle of the bubble tube 103 to change with respect to the reference surface 101A, a sensitivity-setting zero-angle adjustment unit 106 and a measurement zero-angle correction unit 107.

The measurement base portion 101 is formed in a substantially rectangular plate-like shape. The body base portion 102 is provided with a mounting surface 102A on which a bubble tube 103 is mounted on the upper side in a perpendicular direction in a state mounted on the measurement base portion 101. The body base portion 102 is formed in a substantially rectangular shape when viewing the mounting surface 102A from the front and is provided to make a third central axis line C3 in a longitudinal direction of the measurement base portion 101 consistent with a fourth central axis line C4 in a longitudinal direction of the body base portion 102.

The bubble tube 103 is provided with a first bubble tube 108 and a second bubble tube 110 separated at a central portion in a longitudinal direction of the reference surface 101A. The first bubble tube 108 and the second bubble tube 110 are formed in a substantially cuboid-like shape and the liquid 8 and a first bubble 111A or a second bubble 111B are enclosed on the inside of the bubble tubes.

When a fifth central axis line C5 in a longitudinal direction of the first bubble tube 108 and the second bubble tube 110 is projected, the first bubble tube 108 and the second bubble tube 110 are provided to make the fifth central axis line C5 consistent with the third central axis line C3 and the fourth central axis line C4, and are provided to be away from the reference surface 101A from a peripheral portion in the longitudinal direction of the reference surface 101A to a sixth central axis line C6 orthogonal at the central portion to the third central axis line C3 and the fourth central axis line C4. As illustrated in FIG. 7, bubble reading-out surfaces 108A and 110A in a substantially rectangular shape when viewed from the front are defined by an upper side surface in a perpendicular direction in a state in which the first bubble tube 108 and the second bubble tube 110 are mounted on the body base portion 102.

Then, when viewing the bubble reading-out surfaces 108A and 110A from the front with respect to the reference surface 101A, a pair of reading-out lines (reading-out positions) 112A and 112E of a bubble end 111C are provided with the bubble reading-out surfaces 108A and 110A in parallel across the fifth central axis line C5 of the bubble tube 103. The first bubble 111A and the second bubble 111B are formed in such a size that their inside always contains a part of a pair of the reading-out lines 112A and 112B. Note that a pair of the reading-out lines 112A and 112B may be virtually provided as measurement lines by a reading-out sensor (not illustrated). The pair of the reading-out lines are not necessarily in parallel, and may be in bilateral symmetry across the fifth central axis line C5.

The sensitivity-adjustment unit 105 is disposed in the vicinity of the sixth central axis line C6 and in order to increase or decrease the inclination angle of the first bubble tube 108 and the second bubble tube 110 with respect to the reference surface 101A, for example, the sensitivity-adjustment unit 105 is provided with an adjusting bolt 105A, the distal end thereof abuts on the mounting surface 102A, and an adjusting nut 105B formed in a predetermined thickness and into which the adjusting bolt 105A is screwed. Note that the sensitivity-adjustment unit 105 is not limited to this configuration and may be another configuration as long as the configuration increases or decreases the inclination angle of the first bubble tube 108 and the second bubble tube 110 with respect to the reference surface 101A. In addition, the sensitivity-adjustment unit 105 may be disposed only when being manufactured and removed when being shipped.

A sensitivity-setting zero-angle adjustment unit 106 is disposed on the body base portion 102 and adjusts the inclination angle of the body base portion 102 relative to the reference surface 101A. Further, a measurement zero-angle correction unit 107 is disposed on the measurement base portion 101 and changes the inclination angle of the measurement base portion 101 with respect to the horizontal plane.

Next, the operation of the level 100 according to the embodiment will be described.

As illustrated in FIG. 7, when the position where the bubble end 111C becomes parallel in the horizontal plane is assumed to be the reference position E of the ends of bubble 111C, for example, in the case where the measurement surface S is inclined in a direction perpendicular to the fifth central axis line C5 and the fourth central axis line C4, then the first bubble 111A and the second bubble 111B deform. In other words, the first bubble 111A and the second bubble 111B deform such that the bubble end 111C on the reading-out line 112A side is near to the reference position E, while the bubble end 111C on the reading-out line 112B side is away from the reference position E. On the other hand, when the measurement surface S is inclined in the opposite direction, the first bubble 111A and the second bubble 111B deform such that the bubble end 111C on the reading-out line 112A side is away from the reference position E, while the bubble end 111C on the reading-out line 112B side is near to the reference position E.

First, as a preparation, the adjusting bolt 105A of the sensitivity-adjustment unit 105 is operated as to rotate and a predetermined sensitivity-setting angle α is set to increase or decrease the inclination angle with respect to the reference surface 101A of the first bubble tube 108 and the second bubble tube 110. Next, the reference surface 101A is established on the measurement surface S and even if the direction of the body base 102 is changed about 180 degrees with respect to the measurement base portion 101, the measurement zero-angle correction unit 107 is operated such that the difference amount D1 from the reference position E of the bubble end 111C of the first bubble 111A in the bubble reading-out surface 108A and the difference amount D2 from the reference position E of the bubble end 111C of the second bubble 111B in the bubble reading-out surface 110A does not change. With this, an angle with respect to the measured angle of the body base portion 102 itself is corrected to 0.

Then, the sensitivity-setting zero-angle adjustment unit 106 of the one longitudinal direction side 113A or of the other longitudinal side 113B is operated such that the difference amount D1 and the difference amount D2 is identical. With this, an angle with respect to the measured angle of the bubble tube 103 itself is corrected to 0, the sensitivity adjustment angle α is an angle from the horizontal plane and thus preparation for measuring the absolute inclination angle of the measurement surface S is complete.

Here, even if the size of the first bubble 111A and the second bubble 111B changes in accordance with the temperature change or the like, the position of the bubble end 111C merely moves in parallel with the direction of the fifth central axis line C5 when in the horizontal state, so the difference amount D1 and the difference amount D2 of the bubble end 111C do not change.

Further, at the time of inclination measurement, the movement amount of the bubble end 111C is proportional to the amount of inclination and the absolute displacement amount of the bubble movement is determined only by the sensitivity-setting angle α. That is, it is possible to measure the amount of inclination accurately without being affected by changes in the size of the first bubble 111A and the second bubble 111B in accordance with the temperature.

Thus, for example, when the sensitivity-setting angle is one degree, the absolute amount of inclination can be measured from the difference amount between the inclination sensitivity per one tick and the position of the bubble end by setting the inclination amount of 20/1000 to one tick of the difference amount D1, D2 of the bubble end 111C. When measuring, the position of the bubble end 111C is scanned on the pair of reading-out lines 112A, 112B with a reading-out sensor (not illustrated).

According to this level 100, by measuring the difference amount D1, D2 before and after measuring the position of the bubble end 111C on the pair of reading-out lines 112A, 112B, it is possible to measure the amount of inclination of the measured surface S relative to the horizontal plane. In this case, by adjusting the sensitivity-setting zero-angle adjustment unit 106, it is possible to change the inclination angle of the first bubble tube 108 and the second bubble tube 110 with respect to the reference surface 101A to adjust the sensitivity.

Further, as the change amount in the bubble end 111C becomes larger on the distal-end side of the first bubble tube 108 and the second bubble tube 110, the pair of reading-our lines 112A, 112B become more disposed away from the fifth central axis line C5, so when mounting the reference surface 101A on the measurement surface S, the displacement amount of the bubble end 111C on the pair of reading-out lines 112A, 112B are more easily to be read and a more sensitive measurement can be performed.

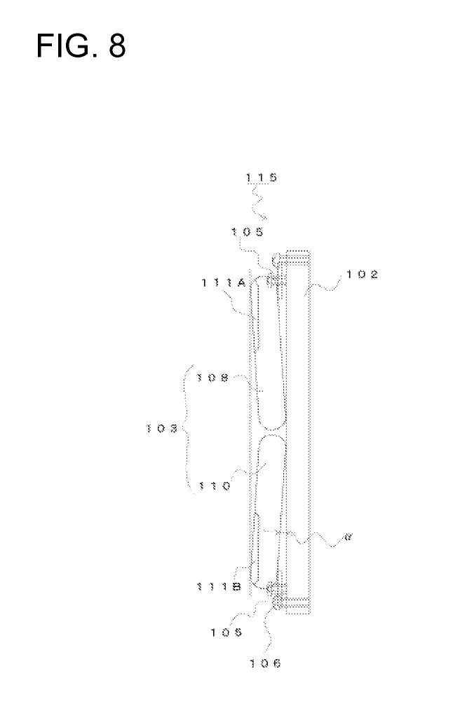

As illustrated in FIG. 8, the first bubble tube 108 and the second bubble tube 110 constituting the bubble tube 103, may be a level 115 provided in a direction for being near to the reference surface 101A in a direction toward a central portion from a peripheral portion across the longitudinal central portion of the reference surface 101A. In this case, the first bubble 111A and the second bubble 111B are disposed on the peripheral side of the reference surface 101A, but they can achieve the same operation and effect as the level 100.

### Fifth Embodiment

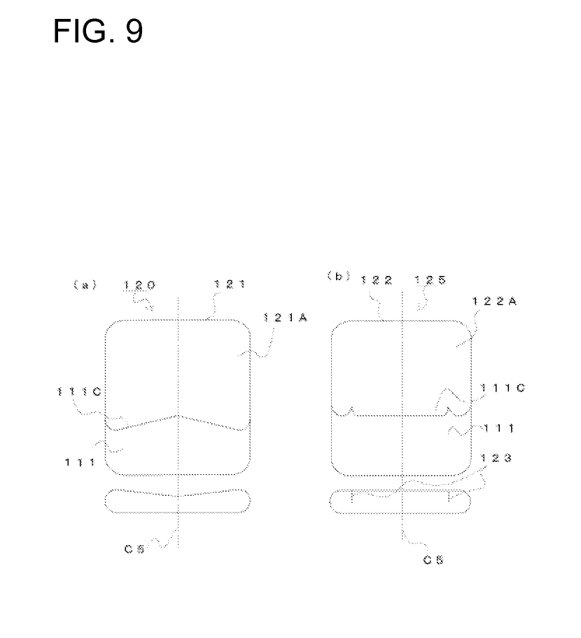

Now, the fifth embodiment will be described with reference to FIG. 9.

Note that structural elements of this embodiment similar to those of the other embodiment described above represent the same reference numerals and descriptions thereof are omitted.

The fifth embodiment differs from the fourth embodiment in that a region close to the fifth central axis C5 of the bubble tube 121 of the level 120 according to the present embodiment is more recessed than a region away from the fifth central axis line C5.

Specifically, as illustrated in (a) of FIG. 9, a bubble reading-out surface 121A of the bubble tube 121 is formed such that it deforms gradually toward the fifth central axis side C5 from the both ends. As illustrated in (b) of FIG. 9, a level 125 may have a region in the vicinity of the fifth central axis C5 that is a planar shape and provided with a convex portion 123 in the region away from the fifth central axis line C5 of the inside of a bubble reading-out surface 122A of the bubble tube 122.

According to the levels 120, 125, the more the bubble 111 in the bubble tubes 121, 122 is away from the fifth central axis line C5, the larger the region that the bubble 111 occupies relatively. Therefore, an influence of a distortion of the bubble reading-out surface 121A, 122A on the position of the bubble ends suppresses, so a change amount in the ends of bubble 111C can be more accurately measured.

### Sixth Embodiment

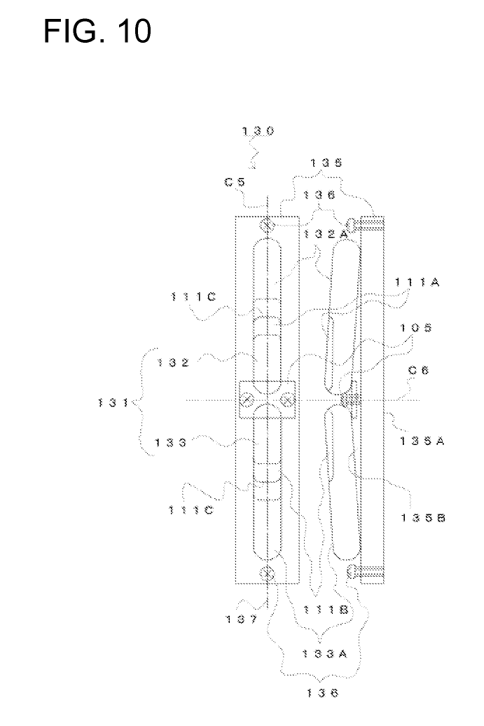

Now, the sixth embodiment will be described with reference to FIG. 10.

Note that structural elements of this embodiment similar to those of the other embodiment described above represent the same reference numerals and descriptions thereof are omitted.

The sixth embodiment differs from the fourth embodiment in that a first bubble tube 132 and a second bubble tube 133 constituting a bubble tube 131 of a level 130 according to the present embodiment is formed in a substantially circular tube.

In the level 130, a measurement base portion 135 also functions as the body base portion 102 in the level 100 according to the fourth embodiment. In other words, the measurement base 135 is provided with a reference surface 135A and a mounting surface 135B. The level 130 is provided with a measurement base zero correction unit 136 combining the functions of the sensitivity-setting zero-angle adjustment unit 106 and the measuring zero-angle correction unit 107 in the level 100.

A reading-out line 137 of the bubble end 111C is provided so as to be consistent with the fifth central axis line C5. Therefore, in the level 130, for example, if the measurement surface S is inclined in the direction of the fifth central axis line C5, the bubble end 111C moves in a direction of the reading-out line 137 parallel to the reference position E.

First, as a measurement preparation, by operating the sensitivity-adjustment unit 105, a predetermined sensitivity-setting angle α is set by increasing or decreasing the inclination angle with respect to the reference surface 135A of the first bubble tube 132 and the second bubble tube 133. Next, the user installs the reference surface 135A on the measurement surface (not illustrated) and operates the measurement base zero correction unit 136 thereby making the difference volume based on the reference position of the bubble end 111C in the bubble reading-out surfaces 132A, 133A consistent on the reading-out line 137. As a result, the sensitivity adjustment angle α becomes an angle from the horizontal plane as well as the sensitivity-setting angle being set during measuring, and the angle with respect to the measurement angle is corrected to 0.

In this way, the absolute amount of inclination is measured from the inclination sensitivity and the difference volume in the position of the bubble ends.

According to the level 130, it is possible to make the inclination direction of the measurement surface consistent with the moving direction of the first bubble 111A and the second bubble 111B, thus an inclination direction is easily recognized.

### Seventh Embodiment

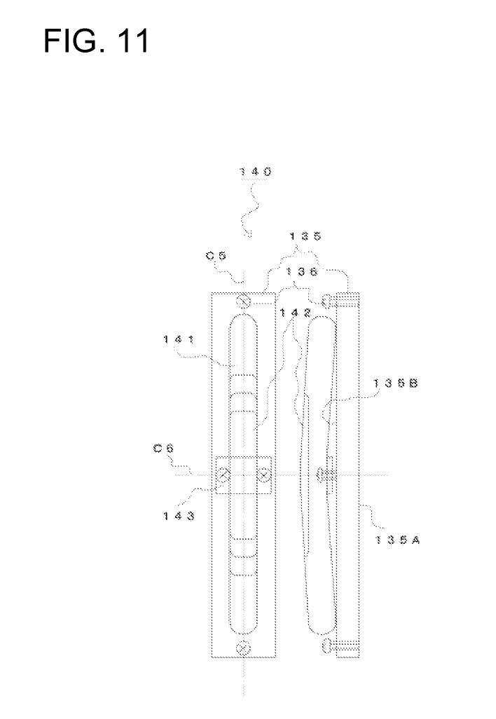

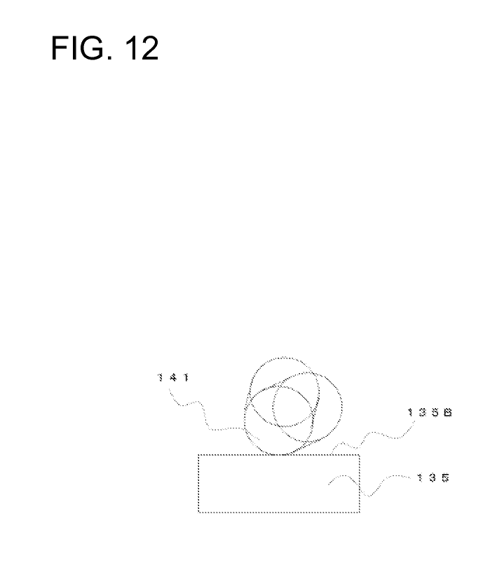

Now, the seventh embodiment will be described with reference to FIGS. 11 and 12.

Note that structural elements of this embodiment similar to those of the other embodiment described above represent the same reference numerals and descriptions thereof are omitted.

The seventh embodiment differs from the sixth embodiment in that a bubble tube 141 of a level 140 is formed by bending slightly from a straight tube state at the longitudinal central portion.

One bubble 142 is enclosed inside a bubble tube 141. The bubble tube 141 is mounted on the mounting surface 135B such that the bent portion of the bubble tube 141 is provided in the longitudinal central portion of the reference surface 135A. Note that the bubble tube may be formed to be curved slightly from a straight tube state at the longitudinal central portion.

A sensitivity-adjustment unit 143 is configured to position the bubble tube 141 with respect to the mounting surface 135B. When adjusting the sensitivity-setting angle, first the fixed state of the bubble tube 141 with respect to the mounting surface 135B is released. Then, as illustrated in FIG. 12, the inclination angle of the bubble tube 141 with respect to the reference surface 135A is changed by rotating the bubble tube 141 itself on the mounting surface 135B. In doing so, the sensitivity-setting angle is adjusted by fixing the bubble tube 141 again at a desired position.

According to this level 140, the inclination angle of the bubble tube 141 with respect to the reference surface 135A can be easily changed by rotating the bubble tube 141 with respect to the mounting surface 135B by the sensitivity-adjustment unit 143.

### Eighth Embodiment

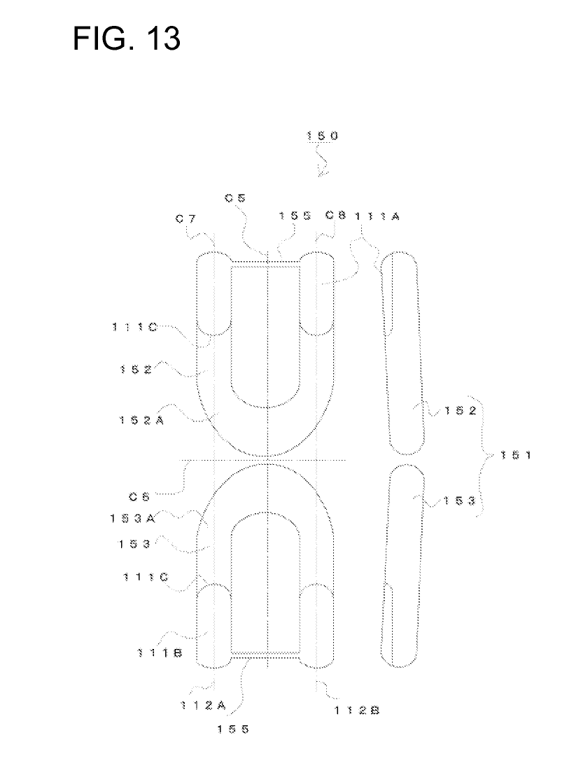

Now the eighth embodiment will be described with reference to FIG. 13.

Note that structural elements of this embodiment similar to those of the other embodiment described above represent the same reference numerals and descriptions thereof are omitted.

The eighth embodiment differs from the fourth embodiment in that a first bubble tube 152 and a second bubble tube 153 constituting a bubble tube 151 of a level 150 according to the present embodiment is substantially U-shaped and that the distal-end sides communicate with each other through a communication tube 155.

The first bubble tube 152 and the second bubble tube 153 are provided in a direction for being near to the reference surface in a direction toward a central portion from a peripheral portion across a longitudinal central portion of the reference surface (not illustrated). Therefore, the first bubble 111A and the second bubble 111B are provided on the distal-end side of the first bubble tube 152 and the second bubble tube 153.

When viewing bubble reading-out surfaces 152A, 153A from the front with respect to the reference surface (not illustrated), the reading-out lines 112A, 112B of the bubble end 111C are provided so that they are consistent with each of the seventh central axis line C7 and the eighth central axis line C8 of the branched portion. In other words, the bubble end 111C moves in the direction of each of the reading-out lines 112A, 112B. For example, however, when the measurement surface S is inclined in the direction of the fifth central axis line C5, the bubble end 111C moves in the same direction on the reading-out lines 112A, 112B. When the measurement surface (not illustrated) is inclined in the direction of the sixth central axis line C6 perpendicular to the fifth central axis line C5, then the bubble end 111C moves in different directions over the reading-out lines 112A, 112B.

According to the level 150, it is possible to measure the inclination amount of the measurement surface and having the same operation and effect as the level 100 according to the fourth embodiment.

Note that the technical range of the present disclosure is not limited to the above embodiments and may be the subject of various changes as long as not departing from the spirit of the present disclosure.

For example, when just measuring whether the measuring plane is inclined with respect to the horizontal plane, then the level may be provided with one out of the first bubble tube body 6 or the second bubble tube body 7, and the sensitivity-setting zero-angle adjustment unit 12 and the measurement zero-angle correction unit 13 may not be provided.

Further, since the absolute position of the bubble is unrelated to the inclination angle, each bubble tube does not need to be formed in bilateral symmetry. The first bubble tube and the second bubble tube, the third bubble tube and the fourth bubble tube, the fifth bubble tube and the sixth bubble tube may each be formed in a different shape and the mutual sensitivity-setting angle may also be different. Even in this case, the inclination angle can be measured by measuring a displacement amount of the bubble end.

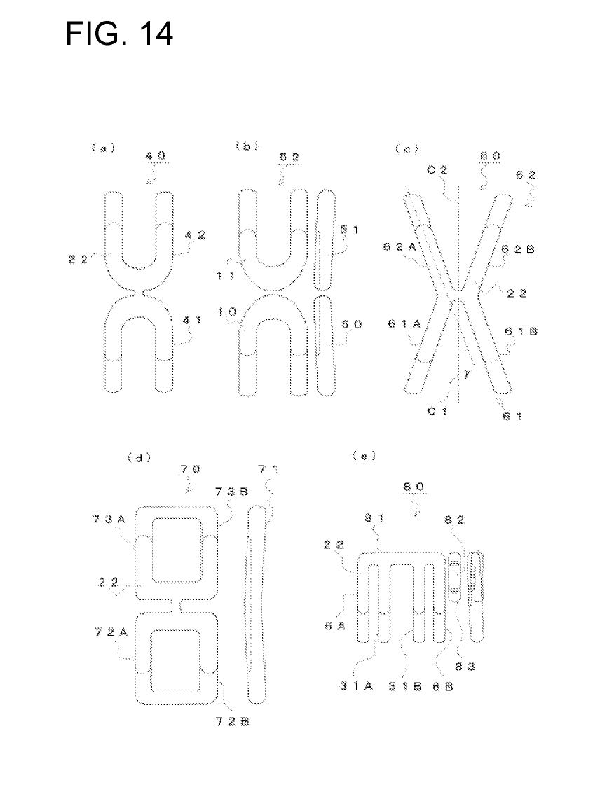

Even further, each bubble tube does not need to be connected so as to be formed in an angled shape as described in each embodiment and, as illustrated in (a) of FIG. 14, the base-end sides of the first bubble tube 41 and the second bubble tube 42 of the level 40 may be connected in a curved state. In this case, the level can be more easily manufactured than when curved halfway in a substantially right angle.

In addition, as illustrated in (b) of FIG. 14, the level 52 may include a first bubble tube body 50 and a second bubble tube body 51 separated from the first bubble tube body 41 and the second bubble tube body 42 of the level 40. In this case, the level is more easily manufactured for there is no connecting portion between the bubble tube bodies.

In addition, as illustrated in (c) of FIG. 14, a first bubble tube body 61A and a second bubble tube 61B in the first bubble tube body 61, and a third bubble tube 62A and a fourth bubble tube 62B in the second bubble tube body 62 of the level 60 may be formed so as to extend from the connecting portion of the base-end side in an orthogonal direction at a certain angle γ with respect to the first central axis line C1 and the second central axis line C2. In this case, the level is more easily manufactured for there is no curved portion.

In addition, as illustrated in (d) of FIG. 14, the distal-end sides of a first bubble tube 72A and a second bubble tube 72B, and a third bubble tube 73A and a fourth bubble tube 73B in the bubble tube body 71 of a level 70 may be further bent and connected to each other with respect to the level 20 according to the second embodiment. In this case, the level 70 can be more easily manufactured than the level 20 in which the distal-end sides are apart from each other.

In addition, as illustrated in (e) of FIG. 14, a level 80 may include a bubble tube body 81 having no third bubble tube 7A and fourth bubble tube 7B of the level 30 according to the third embodiment, and may be provided with a sensitivity-setting zero-correction bubble tube (sensitivity-adjustment unit) 83 with one correction bubble 82 provided on the inside. In this case, by adjusting the position of the correction bubble 82 of the sensitivity-setting zero-correction bubble tube 83 using the sensitivity-setting zero-angle adjustment unit (not illustrated), the sensitivity-setting angle of the bubble tube body 81 can be adjusted. According to the level 80, the level can be further miniaturized while having a plurality of sensitivities.

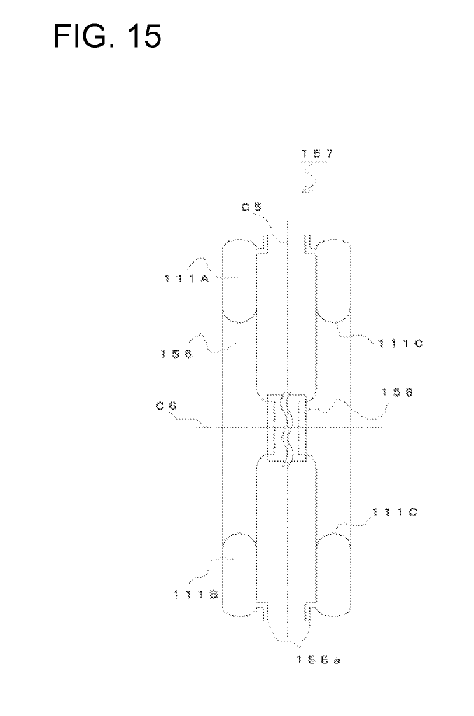

In addition, as illustrated in FIG. 15, a bubble tube 156 viewed from the front may be substantially formed in a uniform H-shape and a level 157 may be bent or curved at the central portion of the fifth central axis line C5. In this case, the level 157 is provided with a stretching portion 158 stretchable along the sixth central axis line C6, and through-holes 156a are provided in the bubble tube 156 instead of the communicating tube 155 to enable measurement of an inclination volume over a longer distance.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A level, comprising:
a measurement base portion having a reference surface arranged thereon to abut on a measurement surface; and
bubble tubes having a liquid and a bubble enclosed therein, the bubble tubes arranged to be inclined at a certain angle in such a fashion that the bubble tubes are away from or near to the reference surface in a direction from a peripheral portion of the reference surface toward a central portion of the reference surface, wherein
the bubble tubes include a first bubble tube and a second bubble tube arranged in such a fashion that base-end sides thereof are connected or opposed to each other, wherein
the base-end sides are positioned at the central portion of the reference surface, and wherein
when the base-end sides are connected to each other, the first bubble tube and the second bubble tube are formed in communication with each other in such a fashion that the bubble defined as a first bubble is movable between the first bubble tube and the second bubble tube, and the first bubble is formed in a size to extend from the first bubble tube to the second bubble tube, and
when the base-end sides are opposed to each other, the bubble is enclosed in each of the first bubble tube and the second bubble tube on a base-end side thereof or a distal-end side thereof.

2. The level according to claim 1 wherein the first bubble tube and the second bubble tube are formed as a pair having base-end sides connected to each other, and the first bubble tube and the second bubble tube are arranged to be inclined with respect to the reference surface in such a fashion that the base-end sides thereof are greater in distance from the reference surface than the distal-end sides thereof.

3. The level according to claim 1, further comprising a sensitivity-adjustment unit for changing an inclination angle of the bubble tubes with respect to the reference surface.

4. The level according to claim 2, further comprising a sensitivity-adjustment unit for changing an inclination angle of the bubble tubes with respect to the reference surface.

5. The level according to claim 2 wherein the first bubble rube and the second bubble tube are formed in a bilaterally symmetrical fashion with respect to a first central axis line.

6. The level according to claim 2, further comprising a scale unit having a plurality of ticks provided at regular intervals on a moving region of a bubble end of the first bubble in the first bubble tube and the second bubble tube.

7. The level according to claim 6 wherein the scale unit is movably arranged with respect to the first bubble tube and the second bubble tube.

8. The level according to claim 2 wherein
the bubble tubes further include a third bubble tube and a fourth bubble tube formed as a pair having a liquid and a second bubble enclosed therein, and the third bubble tube and the fourth bubble tube are arranged on the measurement base portion and have the base-end sides thereof connected in communication with each other in such a fashion that the second bubble is movable between the third bubble tube and the fourth bubble tube, and wherein
the base-end sides of the first bubble tube and the second bubble tube and the base-end sides of the third bubble tube and the fourth bubble tube are arranged to be opposite to each other.

9. The level according to claim 8 wherein
the base-end sides of the third bubble tube and the fourth bubble tube are connected in communication with the base-end sides of the first bubble tube and the second bubble, and wherein
the first bubble and the second bubble are merged into a single bubble.

10. The level according to claim 8 wherein the third bubble tube and the fourth bubble tube are formed in a bilaterally symmetrical fashion with respect to a second central axis line.

11. The level according to claim 9 wherein the third bubble tube and the fourth bubble tube are formed in a bilaterally symmetrical fashion with respect to a second central axis line.

12. The level according to claim 8 wherein
the bubble tubes further include a fifth bubble tube and a sixth bubble tube formed as a pair having the base-end sides thereof connected in communication with each other as well as connected in communication with the base-end sides of the first bubble tube and the second bubble tube so that the fifth bubble tube and the sixth bubble tube have the liquid and the first bubble enclosed therein, wherein
the fifth bubble tube and the sixth bubble tube are arranged in an inside between the first bubble tube and the second bubble tube, or in an outside of the first bubble tube and the second bubble tube.

13. The level according to claim 1, further comprising
a body base portion mounted on the measurement base portion arranged with the bubble tubes, and
a measurement-angle correction unit for adjusting an inclination angle of the body base portion with respect to the reference surface.

14. The level according to claim 1 wherein, when the bubble tube is viewed from a front with respect to the reference surface, a pair of reading-out positions for bubble ends of the bubble are set along a central axis line of the bubble tube or across the central axis line.

15. The level according to claim 2 wherein, when the bubble tube is viewed from a front with respect to the reference surface, a pair of reading-out positions for bubble ends of the bubble are set along a central axis line of the bubble tube or across the central axis line.

16. The level according to claim 1 wherein each of the bubble tubes is arranged in a bent or curved shape at the central portion or in the vicinity of the central portion, of the reference surface.

17. The level according to claim 2 wherein each of the bubble tubes is arranged in a bent or curved shape at the central portion or in the vicinity of the central portion, of the reference surface.

18. The level according to claim 1 wherein each of the bubble tubes has a region in the vicinity of a central axis line thereof recessed more than a region away from the central axis line thereof.

19. The level according to claim 1 wherein each of the bubble tubes has a protrusion formed in a region away from a central axis line thereof in an inside thereof.
